(19) United States
(12) Patent Application Publication
(10) Pub. No.: US 2025/0052781 A1
(43) Pub. Date: Feb. 13, 2025

(54) Atomic Force Microscopy Probe with Tilted Tip and Method of Fabrication Thereof

(71) Applicant: Bruker Nano, Inc., Santa Barbara, CA (US)

(72) Inventors: Jeffrey Wong, Simi Valley, CA (US); Alvaro Rodriguez, Simi Valley, CA (US)

(21) Appl. No.: 18/800,952

(22) Filed: Aug. 12, 2024

Related U.S. Application Data
(60) Provisional application No. 63/531,915, filed on Aug. 10, 2023.

(51) Int. Cl. G01Q 60/38; G01Q 70/10; G01Q 70/16

(52) U.S. Cl. CPC G01Q 60/38; G01Q 70/10; G01Q 70/16

(57) ABSTRACT

A method of batch-fabricating an array of probe devices for a surface analysis instrument, such as an atomic force microscope (AFM), includes providing a wafer, and photolithographically forming a base and a cantilever for each probe. The cantilever includes a built-in angle, θ, relative to the base, and the base is substantially parallel to a sample holder when the probe device is mounted in a probe holder of the surface analysis instrument.

### CROSS-REFERENCE TO RELATED APPLICATIONS

This application claims priority under 35 USC § 1.119 (e) to U.S. Provisional Patent Application No. 63/531,915, filed on Aug. 10, 2023. The subject matter of this application is hereby incorporated by reference in its entirety.

### BACKGROUND OF THE INVENTION

### Field of the Invention

The preferred embodiments are directed to a probe device for a metrology instrument and a corresponding method of manufacture, and more particularly, an atomic force microscope (AFM) probe device that includes a cantilever having a tilted tip to facilitate measurement needs on varying sample types.

### Description of Related Art

Scanning probe microscopes (SPMs), such as the atomic force microscope (AFM), are devices which use a cantilever mounted tip and low forces to characterize the surface of a sample down to atomic dimensions. Generally, the tip of the SPM probe is introduced to the sample surface to detect characteristics of the sample. By providing relative scanning movement between the tip and the sample, surface characteristic data can be acquired over a particular region of the sample and information specific to the region can be determined, such as a corresponding map of the sample can be generated, properties of the sample such as the elastic modulus, stiffness, displacement, etc.

AFMs typically employ probes that are flat or include some small, unintentional angle with a cantilever extending from a base, and the cantilever and the surface of the base from which it extends being substantially in the same plane. The tip resides about the distal end of the cantilever and most often extends orthogonally from the plane of the cantilever.

An overview of AFM and its operation follows. A typical AFM system is shown schematically in FIG. 1. An AFM 110 employing a probe device 112 including a probe 114 having a cantilever 115. Scanner 124 generates relative motion between the probe 114 and sample 122 while the probe-sample interaction is measured. In this way images or other measurements of the sample can be obtained. Scanner 124 is typically comprised of one or more actuators that usually generate motion in three orthogonal directions (XYZ). Often, scanner 124 is a single integrated unit that includes one or more actuators to move either the sample or the probe in all three axes, for example, a piezoelectric tube actuator. Alternatively, the scanner may be an assembly of multiple separate actuators. Some AFMs separate the scanner into multiple components, for example an XY scanner that moves the sample and a separate Z-actuator that moves the probe. The instrument is thus capable of creating relative motion between the probe and the sample while measuring the topography or some other surface property of the sample as described, e.g., in Hansma et al. U.S. Pat. No. RE 34,489; Elings et al. U.S. Pat. No. 5,266,801; and Elings et al. U.S. Pat. No. 5,412,980.

In a common configuration, probe 114 is often coupled to an actuator or drive 116 that is used to oscillate probe 114 at or near a resonant frequency of cantilever 115. Alternative arrangements measure the deflection, torsion, or other motion of cantilever 115. Probe 114 is often a microfabricated cantilever with an integrated tip 117.

Commonly, an electronic signal is applied from an AC signal source 118 under control of an SPM controller 120 to cause actuator 116 (or alternatively scanner 124) to drive the probe 114 to oscillate. The probe-sample interaction is typically controlled via feedback by controller 120. Notably, the actuator 116 may be coupled to the scanner 124 and probe 114 but may be formed integrally with the cantilever 115 of probe 114 as part of a self-actuated cantilever/probe.

Often a selected probe 114 is oscillated and brought into contact with sample 122 as sample characteristics are monitored by detecting changes in one or more characteristics of the oscillation of probe 114, as described above. In this regard, a deflection detection apparatus 125 is typically employed to direct a beam towards the backside of probe 114, the beam then being reflected towards a detector 126. As the beam translates across detector 126, appropriate signals are processed at block 128 to, for example, determine RMS deflection and transmit the same to controller 120, which processes the signals to determine changes in the oscillation of probe 114. In general, controller 120 generates control signals to maintain a relative constant interaction between the tip 117 and sample 122 (or deflection of the lever 115), typically to maintain a setpoint characteristic of the oscillation of probe 114. More particularly, controller 120 may include a PI Gain Control block 132 and a High Voltage Amplifier 134 that condition an error signal obtained by comparing, with circuit 130, a signal corresponding to probe deflection caused by tip-sample interaction with a setpoint. For example, controller 120 is often used to maintain the oscillation amplitude at a setpoint value, AS, to insure a generally constant force between the tip 117 and sample 122. Alternatively, a setpoint phase or frequency may be used.

A workstation 140 is also provided, in the controller 120 and/or in a separate controller or system of connected or stand-alone controllers, that receives the collected data from the controller 120 and manipulates the data obtained during scanning to perform point selection, curve fitting, and distance determining operations.

The optical sensing/detecting systems of AFM tools use a laser to bounce off a probe's cantilever and onto a sensor that detects, e.g., sub-nanoscale displacements. The laser source and the sensor are located a certain distance apart from each other, which makes it necessary for the laser to deflect off the cantilever at a known angle in order to be detected by the sensor. The traditional approach is to machine-in the known angle into the probe's mounting fixture, i.e., probe holder. This is illustrated schematically in FIG. 2.

FIG. 2 shows a probe device 250 mounted in an AFM head/probe holder 252. Probe device 250 includes a base 254 with a probe 256 extending therefrom, in line with a bottom surface 269 of base 254. Probe 256 includes a cantilever 258 having a distal end 260 supporting a tip 262 that interacts with a surface 265 of a sample 264 supported by a sample holder 267 during AFM operation. The tip 262 shown in FIGS. 1 and 2 is a probe tip having a plateaued surface 261 at its distal end 263 remote from the cantilever 258. As noted, AFM head 252 or a portion thereof (e.g., a probe holder) may be configured to accommodate probe device 250 so that the device extends from probe holder 252 at an angle thereby positioning tip 262 of probe 256 so it extends generally orthogonally to the sample surface 265. Probe assembly 250 is held in head 252 with, for example, a spring-loaded clip 266.

However, having a probe tip 262 that extends fully orthogonal to the cantilever 258 may be impractical where the type of scanning requires use of a probe tip 262 that includes a plateaued surface 261 or where the probe tip 262 is particularly long extending from the cantilever 258 (i.e., has a high aspect ratio). Current tip fabricating techniques cannot be used to reliably or consistently form plateaued tips and/or extended tips that do not extend orthogonally from the cantilever 258 such that they will be orthogonal to a sample surface when used in probe device 250.

Plateaued tips that extend orthogonal to a cantilever can be formed and/or shaped to have an angle that will be orthogonal to a sample surface 265. However, a plateaued tip that extends orthogonally from a cantilever that includes a plateaued surface that is parallel to the cantilever will not properly engage or otherwise interact with a sample surface 265, limiting the application and accuracy. Typically, these tips only have a 12% engagement with the sample surface 265. Other techniques may be used to shape angled plateaus at a tip apex. Forming an angled plateau at the distal end of a probe tip 262 may be performed using, for example, a focused ion beam tool on individual probes. However, such an operation requires high precision, is time-consuming, and costly. Another technique, electron beam deposition may also be used to form short AFM tips on top of existing tips or pedestals. However, this technique cannot easily be used to reliably create large platforms at the tip apex and/or to create tall, high aspect ratio AFM tips.

In view of the above, the field of atomic force microscopy was in need of a probe that allows for tall and/or plateaued probe tips to be formed orthogonally from a cantilever while providing the integrity and proper orientation in a tip engagement/sample surface relationship. A method for reliable and cost-effective fabrication of such probes was also desired.

Note that “SPM” and the acronyms for the specific types of SPM's, may be used herein to refer to either the microscope apparatus, or the associated technique, e.g., “atomic force microscopy.”

### SUMMARY OF THE INVENTION

The preferred embodiments overcome the drawbacks of prior solutions by providing a probe with a tall and/or plateaued tip that is properly aligned with a sample surface, as well as a corresponding method of manufacture, that provides a user experience that is very repeatable and consistent from probe-to-probe. The fabrication of a designed cantilever angle as discussed herein can be applied to nearly all AFM probe products. Since this process allows for batch fabrication, cost to manufacture is very similar to the cost of existing products and results in high yields.

According to a first aspect of the preferred embodiment, a method of batch-fabricating probe devices for a surface analysis instrument includes providing a probe, the probe including a cantilever defining a longitudinal cantilever axis and a probe tip having an engagement surface substantially parallel to the cantilever axis. The method further includes removing a portion of the probe; and increasing or decreasing the size of the removed portion of the probe to generate a tilted probe tip having an engagement surface that deviates from being parallel with the longitudinal cantilever axis.

In another aspect, removing a portion of the probe includes using a focused ion beam to remove a portion of the probe. The removed portion of the probe may be a portion of the cantilever and/or the probe tip. In another embodiment, removing a portion of the probe includes using lithography combined with dry/wet etching.

In a further aspect of this embodiment, increasing or decreasing the size of the removed portion of the probe includes using LOCOS oxidation to selectively grow oxide inside the removed portion to expand the size of the removed portion. The deviation from the angle of the longitudinal cantilever axis may be between 8°-15°. Preferably, the angle is about 12°.

In another aspect of this embodiment, removing the portion of the probe includes implanting a selectively expandable material within the removed portion of the probe. The selectively expandable material may be an implanted doped silicon.

In another probe embodiment, a probe device for a surface analysis instrument including a probe holder includes a cantilever defining a longitudinal cantilever axis and a tilted probe tip having an engagement surface that an engagement surface, the angle of which deviates from being parallel with the longitudinal cantilever axis. The probe device includes an expanded filler in a removed portion of the probe device and the size of the removed portion has been modified by the expanded filler to provide the angle deviation of the engagement surface.

In a further aspect of this embodiment, the removed portion of the probe includes oxide grown using LOCOS oxidation.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is a schematic illustration of a Prior Art surface analysis instrument such as an atomic force microscope (AFM);

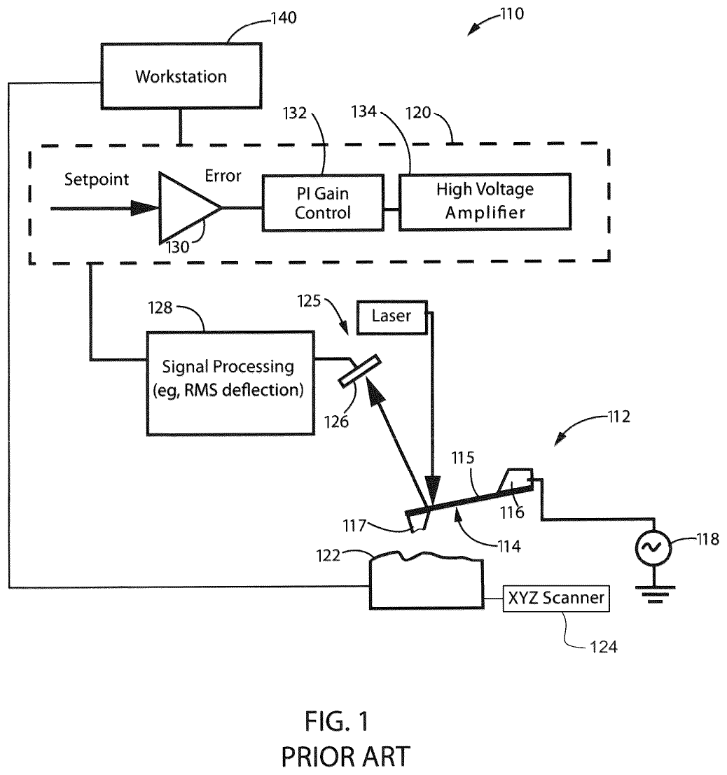

FIG. 2 is a schematic side elevational view of a Prior Art probe fabricated in conventional fashion mounted in a probe holder, the probe holder manufactured with an angle while the tip of the probe extend orthogonally to a cantilever of the probe;

FIG. 3 is a schematic side elevational view of a probe mounted in an AFM head and fabricated according to a preferred embodiment with a base of tip extending orthogonally from the cantilever but either the cantilever or the tip formed to be non-linear/with an angle, according to an exemplary embodiment;

FIG. 4 is a flow chart illustrating a method of fabricating a probe a portion of which is angled, according to an exemplary embodiment;

FIGS. 5A-5C are schematic side elevational views of an AFM probe being microfabricated according to the method of FIG. 4 so as to have a cantilever angled relative to the probe base, according to a preferred embodiment;

FIGS. 6A-6C are schematic side elevational views of an AFM probe being microfabricated according to the method of FIG. 4 so as to have a cantilever angled relative to the probe base, according to an exemplary embodiment;

FIGS. 7A-7C are schematic side elevational views of a probe having a tilted tip engagement surface fabricated according to the method shown in FIG. 4, according to an exemplary embodiment;

FIGS. 8A-8C are schematic side elevational views of a probe having a tilted tip engagement surface fabricated according to the method shown in FIG. 4, according to an exemplary embodiment;

FIG. 9 is a schematic side elevational views of a probe having a tilted tip engagement surface fabricated according to an alternative method, according to an alternative embodiment;

FIG. 10 is a schematic side elevational views of a probe having a tilted tip engagement surface fabricated according to an alternative method, according to an alternative embodiment; and

FIGS. 11A-D are SEM images of side views of a probe having a tilted tip engagement surface fabricated as described herein.

### DETAILED DESCRIPTION OF THE PREFERRED EMBODIMENTS

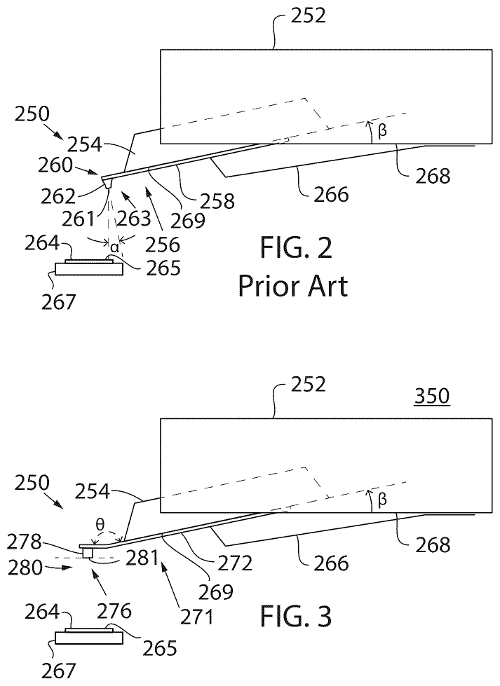

Referring again to FIG. 2, probe device 250 for use in a surface analysis instrument such as an atomic force microscope (AFM) and fabricated in conventional fashion is mounted in the AFM head/probe holder 252, for example, at an angle β, between a bottom surface 269 of substrate or base 254 of probe device and a bottom surface 268 of the AFM/probe holder. In this way, the probe tip extends beyond the bottom most portion on the probe holder 252 such that holder 252 does not interfere with the surface 265 to be imaged. This is typically accomplished with an appropriately machined probe holder that can then be mounted in the AFM head. The drawbacks of this arrangement have been discussed previously, including that a probe tip 262, in this case having a plateaued tip 261, extending entirely orthogonally from the cantilever 258 will not be aligned to engage with the surface 265 optimally.

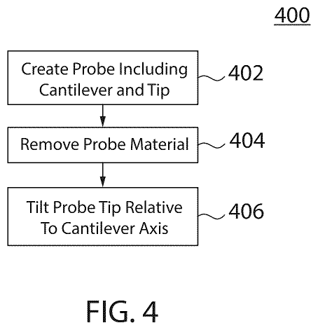

Turning to FIG. 3, probe device 350, similar to probe device 250 of FIG. 2 except as noted below, including probe 271 having a cantilever 272 extending from base 254 of device 350 formed from a substrate (e.g., photolithographically patterned on a silicon wafer) includes a free end 276 supporting a tip 278. Cantilever 272 defines a cantilever longitudinal axis along its longest length. Tip 278 of probe device 350 includes a plateaued distal end 280 (i.e., apex). Notably, unlike the cantilever of probe 256 of the prior art (FIG. 2), which extends linearly from its interface with the base to its distal end supporting its tip 262, probe 271 includes a tilted distal end 280 that defines an engagement surface 281 (flat or plateaued in this case) that is at a set angle, θ from the cantilever longitudinal axis. The fabrication of probe 271 with a tilted tip, and variations in its formation, are discussed further below. The operational difference is that the engagement surface 281 will be more aligned to engage with a sample surface 265 increasing measurement accuracy.

With the known probe 256 in FIG. 2, when probe device 250 is mounted in the head 252, the tip 262 extends substantially orthogonally from the cantilever 258, but is not substantially orthogonal to the sample surface 265—it is disposed at an angle, a. In the preferred embodiments, in contrast, the probe device 350 is formed such that the base of the tip 278 is substantially orthogonal to the cantilever while the engagement surface 281 is orthogonal to the sample surface 265. In this case, the tip 278 (in this case, a plateaued tip) may be easily formed on the orthogonal cantilever without additional, costly, inefficient, and inaccurate modification while the engagement surface 281 is also substantially orthogonal to the sample surface 265 to improve engagement between the tip 278 and sample.

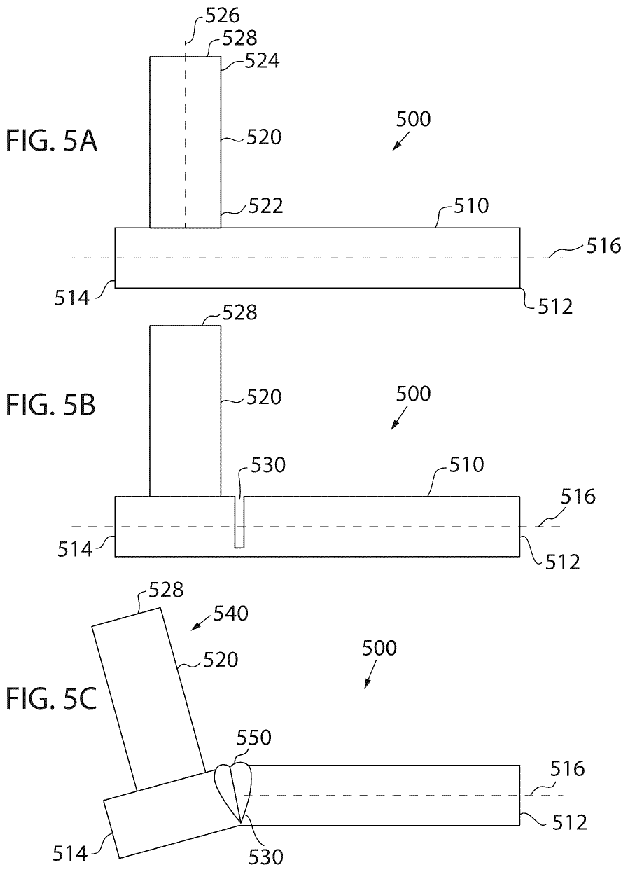

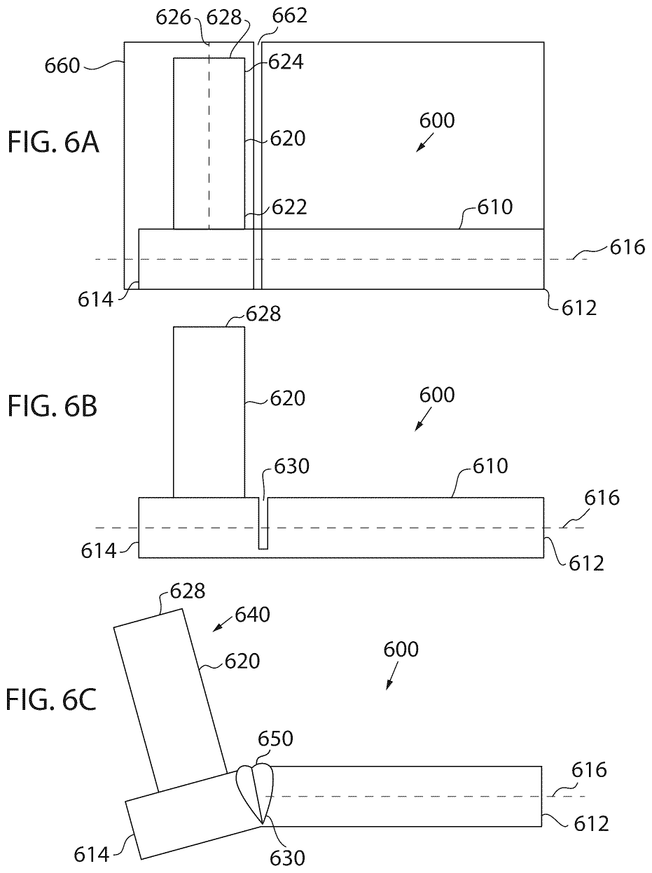

The microfabrication process for making probes with this built-in angle is set forth in the flow diagram of FIG. 4 and will be described together with an illustration of variations for specific steps of the probe fabrication in FIGS. 5-10. A method 400 for fabricating AFM probes having a tilted tip is shown in FIG. 4, according to an exemplary embodiment. Initially, in Step 402, a probe is created, for example using standard photolithography and wet/dry etch processes to create the probe, including a cantilever and a tip. The tip may be created with various dimensions and shapes, such as a cylindrical tip with a 20:1 or 25:1 aspect ratio, whereby the formed tip is relatively taller than standard embodiments.

As formed, the cantilever will have an elongated linear axis. The longitudinal cantilever axis (516, 616, 716) extends along the longest length of the cantilever as shown in FIGS. 5-8, but not necessarily the entire length. At formation of the probe in step 402, the cantilever axis will be substantially orthogonal to a tip longitudinal axis (for example, axis 526 in FIG. 5A). A distal end of the tip will include an engagement surface that is substantially parallel with the cantilever axis at formation of the probe in step 402. The created cantilever, longitudinal cantilever axis, tip and tip axis are show and described below with reference to FIGS. 5A-8A.

Method 400 then includes, in a step 404, removing a portion of the probe after the creation of the tip and probe. The removal of the portion of the probe may include a removal of probe materials at the end of probe that include the tip and distal portion of the cantilever. The removal of the portion of the probe may include removal of material at a single location or a plurality of locations. Specific examples of material removal are shown as described below with reference to FIGS. 5B-10.

In Step 406, the probe is modified to create a tilted tip. A tilted tip includes an engagement surface that is no longer substantially parallel to the longitudinal cantilever axis. The degree of the angle of deviation will be provided such that the engagement surface will be substantially orthogonal to a sample surface when the probe is inserted into a probe device 350 as shown in FIG. 3. Specific examples of tilted tip formation are shown as described below with reference to FIGS. 5-10.

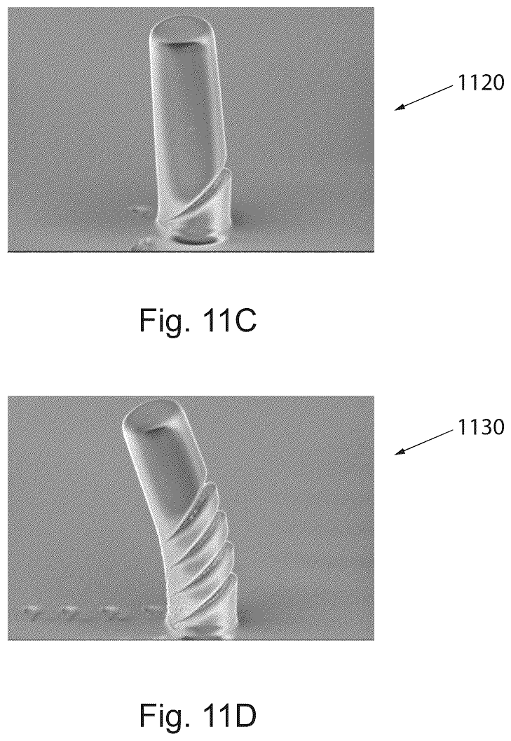

In an alternative embodiment, step 404 may be iteratively performed to remove multiple portions of the probe at different locations along the cantilever. Following the removal of multiple portions, step 406 may be iteratively performed. Advantageously, removing multiple portions allows for an increased angle of deviation, such as to a full 180-degrees (see FIG. 11B). In an additional alternative embodiment, steps 402-406 may be performed in a different order, such that the tilting of the tip can occur prior to creating the freestanding cantilever.

Advantageously, a tilted tip having an engagement surface that is essentially parallel to a sample surface can provide a more accurate and complete measurement of the sample. Further, having cylindrical tips with for example a 25:1 aspect ratio, such that the formed tip is relatively taller than standard embodiments, can provide a more accurate sidewall and bottom measurement for deeper sample features based on the height of the probe tip and orthogonal orientation of the probe relative to features extending into the sample from the sample surface.

Referring now to FIG. 5A, a probe 500 is created as described in step 402. Probe 500 includes a cantilever 510 and a tip 520, formed using known techniques for probe formation such as standard photolithography and wet/dry etch processes.

Cantilever 510 includes a cantilever proximal end 512, a cantilever distal end 514 upon which tip 520 is formed, and a longitudinal cantilever axis 516 that extends along the longest length of the cantilever. Tip 520 includes a tip proximal end 522 abutting cantilever 510, a tip distal end 524, and a longitudinal tip axis 526. Longitudinal tip axis 526 is substantially orthogonal to longitudinal cantilever axis 516 during the creation of the tip in step 402. Tip 520 further includes an engagement surface 528 that is substantially parallel to the longitudinal tip axis during the creation of the probe in step 402.

Again, probe 500 may be mass produced at the wafer level. Specifically, a wafer may be processed using standard lithography and wet/dry lithography according to the methods described herein to create approximately, for example, four hundred (400) probes 500.

Referring next to FIG. 5B, probe 500 may then be processed in step 404 to remove a portion of the probe 500 material. In this case, the material is removed from the distal end 514 of the probe 500 from the cantilever 510 and/or the tip 520 to facilitate the formation of the tilted tip of the present invention. In FIG. 5B, a portion of the cantilever 510 at the distal end 514 of cantilever 510, proximate to the tip 520, has been removed to facilitate the formation of the tilted tip. The removed material forms a trench 530. In the example shown, the trench 530 was formed using a focused ion beam (FIB) tool. Trench 530 may also be formed by lithography or an alternative microfabrication process as are known in the art. Although only a single trench 530 is shown, it should be understood that multiple trenches 530 may be formed.

For the embodiment shown in FIG. 5B, trench 530 is formed in the cantilever 510 on the side of tip 520 that is closer to the proximate end 512 of cantilever 510. The trench 530 is formed close to tip 520 to facilitate tilting of the tip 520 and to maximize the non-tilted portion of the cantilever 510 for laser beam reflection. Using a FIB tool, both the depth and width of the trench 530 may be controlled, although the preferred embodiment produces a deep and narrow trench that will facilitate the tipping method. In a typical example, a trench 530 may be 3.0 microns deep and 1.0 micron across. Advantageously, tilt sensitivity as the width of the slice decreases-precision is required in creating a specific angle of tilt. In the end, the FIB tool may be utilized to create sub-micron widths at multiple microns depth.

Referring now to FIG. 5C, probe 500 may then be further processed in step 406 to form the tilted tip of the present invention. In the embodiment shown in FIG. 5C, the size and shape of slot or trench 530 is modified using Local Oxidation of Silicon (LOCOS) to form the tilted tip 540. In an exemplary embodiment, thermal oxidation is used because of the mask opening. LOCOS oxidation allows for selective growth of oxide to form and expanded filler 550 in trench 530. Depending on the width and depth of the trench 530, the selective growth of the oxide to an oxide thickness will create tilted tip 540 having an engagement surface 528 that is no longer substantially parallel to the longitudinal tip axis but is configured to provide improved engagement with a tip surface when the probe 500 is used in a probe device 350 as shown in FIG. 3. The oxide thickness will ultimately determine the tip angle of tip 540, although wide ranges of angle are possible using the methods described herein, a 10-12° tilt from the longitudinal cantilever axis 516 is typical.

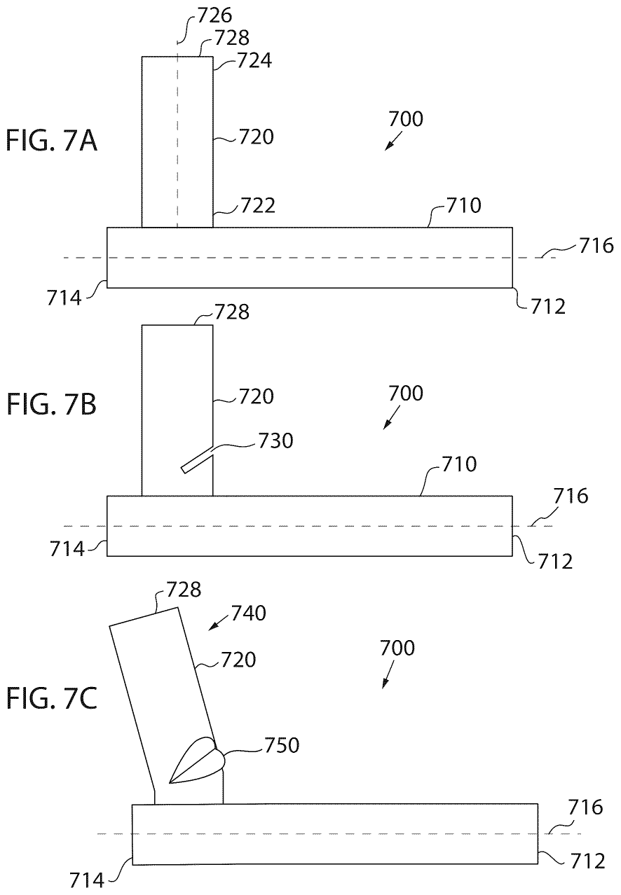

Referring now to FIGS. 6A-C, a probe 600 including a tilted tip, formed using an alternative method, is shown, according to an exemplary embodiment. The probe 600 shown in FIG. 6A is the same as probe 500 as shown and described with reference to FIG. 5A. However, probe 600 has been configured to include a patterned photoresist or other removable masking material 660 that defines a mask opening 662 corresponding to a desired location to initiate the tip tilt. The mask material 660 may be applied using lithography techniques to define an approximately one (1) micron opening 662. Although this method requires application of relative thick photoresist, the method is easily applied in batch fabrication across a wafer to form probes 600.

Referring now to FIG. 6B, probe 600 may then be processed in step 404 using standard photolithography with an ion implantation 650 in an etched trench 630 to implant a species, such as doped silicon, that will selectively expand the volume of the implanted region as-is, or after treatment such as thermal oxidation as shown in FIG. 6C. Referring now also to FIG. 6C, probe 600 may then be processed in step 406 to form the tilted tip of the present invention. In the embodiment shown in FIG. 6C, the size and shape of ion implantation 650 is modified using, for example, thermal oxidation to form the tilted tip 640. In an exemplary embodiment, thermal oxidation is used because of the mask opening. Thermal oxidation also allows for selective growth to form an expanded filler that is the ion implantation 650. Depending on the nature and size of the ion implantation 650, the selective expansion of the localized material will create tilted tip 640 having an engagement surface 628 that is no longer substantially parallel to the longitudinal tip axis but is configured to provide improved engagement with a tip surface when the probe 600 is used in a probe device 350 as shown in FIG. 3.

In an alternative embodiment, the exposed silicon does not necessarily need to be implanted. The implanted silicon will increase the tilt sensitivity during thermal oxidation, but un-implanted silicon will expand as well during thermal oxidation if there is a masking material (e.g., silicon nitride) that will prevent oxidation of silicon in the surrounding regions (LOCOS).

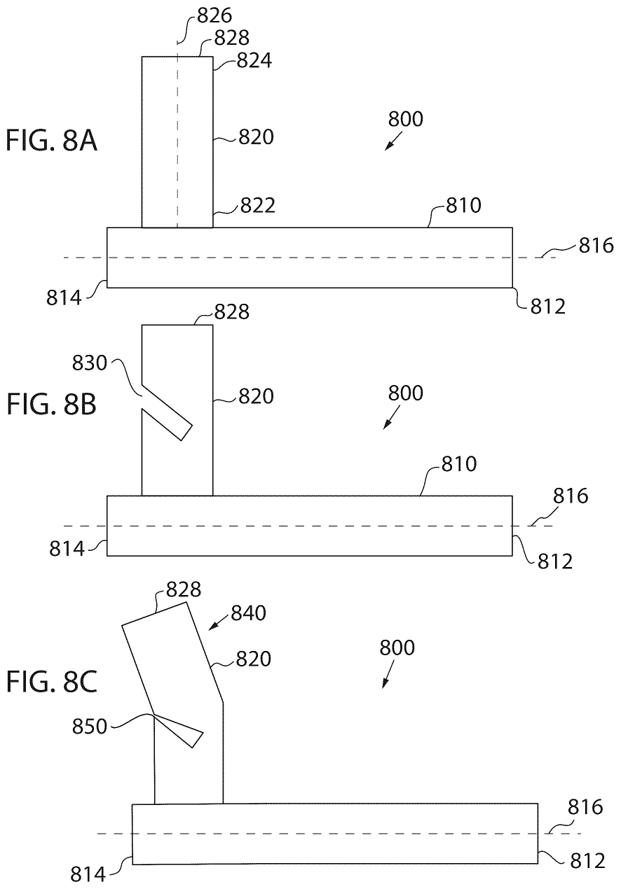

Referring now to FIGS. 7A-C, a probe 700 including a tilted tip, formed using an alternative method, is shown, according to an exemplary embodiment. The probe 700 shown in FIG. 7A is the same as probe 500 as shown and described with reference to FIG. 5A.

Referring now to FIG. 7B, probe 700 may then be processed in step 404 to remove a portion of the probe 700 material. The material is removed from the distal end 714 of the probe 700 from the tip 720 to facilitate the formation of the tilted tip of the present invention. In the embodiment shown in FIG. 7B, a portion of the tip 720 has been removed to facilitate the formation of the tilted tip. The removed material forms a slot or trench 730. In the example shown, the trench 730 was formed using a focused ion beam (FIB) tool, similar to trench 530 with the FIB positioned at a different location and angle to facilitate the trench 730 formation. Although only a single trench 730 is shown, it should be understood that multiple trenches 730 may again be formed.

Trench 730 may be deformed using an expanded filler creation method, such as those described above with reference to FIGS. 5 and 6. Advantageously, using the steps shown in FIGS. 7A-C, probe 700 may be formed without interference to cantilever 710, thereby providing an advantage of reducing an incidence of scattering light from the beam-bounce detection scheme that may occur with an angle formed in the cantilever.

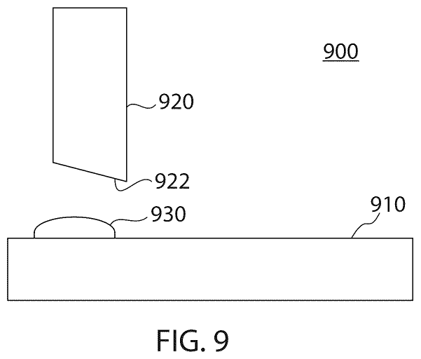

Referring now to FIGS. 8A-C, a probe 800 including a tilted tip, formed using an alternative method, is shown, according to an exemplary embodiment. The probe 800 shown in FIG. 8A is the same as probe 500 as shown and described with reference to FIG. 5A.

Referring now to FIG. 8B, probe 800 may then be processed in step 404 to remove a portion of the probe 800 material. The material is removed from the distal end 814 of the probe 800 from the tip 820 to facilitate the formation of the tilted tip of the present invention. In the embodiment shown in FIG. 8B, a portion of the tip 820 has been removed from the side of tip 820 closest to the distal end 814 to facilitate the formation of the tilted tip. The removed material forms a trench or slot 830. In the example shown, the trench 830 was formed using a focused ion beam (FIB) tool, similar to trench 530 with the FIB positioned at a different location and angle to facilitate the trench 830 formation. Although only a single trench 830 is shown, it should be understood that multiple trenches 830 may again be formed.

Trench 830 may then be deformed using manual manipulation of the tip 820 (e.g., thermal processing to deform the tip) to form compressed cavity 850. Advantageously, using the steps shown in FIGS. 8A-C, probe 800 may be formed without additional filler materials.

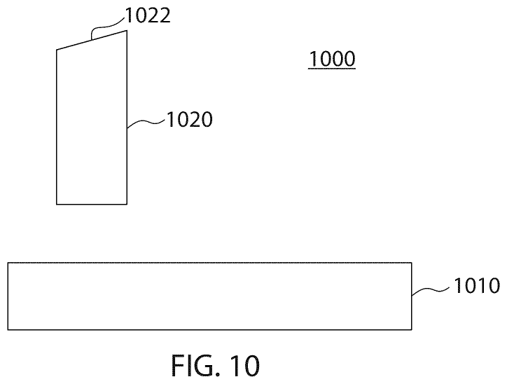

Referring now to FIG. 9, unlike the previous embodiments which begin with a fully formed probe assembly, cantilever and tip, a probe 900 is created to include a tilted tip upon manufacture of components of the probe. Probe 900 includes a cantilever 910 and a tip 920, formed using known techniques for probe formation such as standard photolithography and wet/dry etch processes. Tip 920 includes a removed portion 922 of the tip 920, typically using individual machining, usage of an FIB tool, etc. To assemble, tip 920 may be glued to the cantilever 910 at the removed portion in conventional fashion to provide a tilted tip as otherwise described herein.

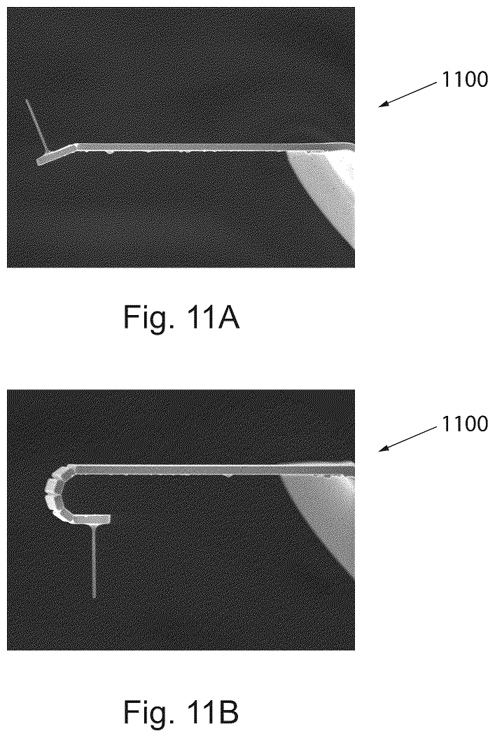

Referring next to FIG. 10, a probe 1000 is created to include a tilted tip upon assembly of the probe. Probe 1000 includes a cantilever 1010 and a tip 1020, formed using known techniques for probe formation such as standard photolithography and wet/dry etch processes. Tip 1020 includes a removed portion 1022 at a distal or engagement end of the tip 1020, typically using individual machining, usage of an FIB tool, etc. Upon assembly, the base of the tip 1020 may be attached to the cantilever 1010 at the end of probe tip 1020 opposite the removed portion to provide a tilted tip as otherwise described herein. The probe tip 1020 may be attached to cantilever 1010 using glue or common bonding methods such as fusion, eutectic, and anodic bonding.

The tip may be formed orthogonally to the cantilever to facilitate tight control of tip height and tip diameter, from sub-micron to tens of microns for example. Further, tips may be more easily coated with different materials to functionalize the tip for various applications, where the tip coating will not be affected by subsequent processing steps. Yet further, tips may be easily coated with robust materials that are resistant to wear and harsh environments. For example, the probe may be coated with a mask material, such as silicon nitride. Processing is done at the wafer level for improved performance, lower cost, and consistent user experience. The functional engagement surface portion of the tip, the distal end opposite the proximal end abutting the cantilever, is fully formed, and is not modified in creating the tilted tip described hereinbelow.

Referring next to FIG. 11A, an SEM image 1100 of a probe assembled to include a tilted tip is shown, according to an exemplary embodiment. The assembled probe is shown as having a tilted tip formed based on material removal from the cantilever and subsequent processing to form the desired tip angle.

Referring next to FIG. 11B, an SEM image 1110 of a probe assembled to include a tilted tip is shown, according to an exemplary embodiment. The assembled probe is shown as having a tilted tip formed based on multiple instances of material removal from the cantilever and subsequent processing to form a 180-degree tip angle.

Referring next to FIG. 11C, an SEM image 1120 of a probe assembled to include a tilted tip is shown, according to an exemplary embodiment. The assembled probe is shown as having a tilted tip formed based on material removal from the tip and subsequent processing to form the desired tip angle.

Referring next to FIG. 11D, an SEM image 1130 of a probe assembled to include a tilted tip is shown, according to an exemplary embodiment. The assembled probe is shown as having a tilted tip formed based on multiple instances of material removal from the tip and subsequent processing to form the desired tip angle.

Using the described methods and probes, the user experience is very repeatable and consistent from probe to probe when batch fabricated as described herein. Batch fabrication permits tight control of parameters of particular interest to the user, such as but not limited to Frequency, Stiffness, Tip Height, Tip Diameter, and Conductivity. In sum, application of the preferred probe design and fabrication techniques encompasses a broad spectrum of already existing AFMs, probes and their associated applications. Moreover, the tilted tips on these cantilevers can be fully formed and masked and/or otherwise treated before the probe is modified or assembled to utilize a tilted tip, and therefore, the lifetime of the probe devices is enhanced.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

We claim:

1. A method of batch-fabricating an array of probe devices for a surface analysis instrument, the method including:
providing a probe, the probe including
a cantilever defining a longitudinal cantilever axis, and
a probe tip;
removing a portion of the probe; and
increasing or decreasing the size of the removed portion of the probe to generate a tilted probe tip having an engagement surface that deviates from being parallel with the longitudinal cantilever axis.

2. The method of claim 1, wherein the removed portion of the probe is at least a portion of one of the tip and the cantilever.

3. The method of claim 2, wherein removing a portion of the probe includes using a focused ion beam to remove a portion of the probe.

4. The method of claim 2, wherein removing a portion of the probe includes using lithography combined with at least one of dry and wet etching.

5. The method of claim 1, wherein increasing or decreasing the size of the removed portion of the probe includes using LOCOS oxidation to selectively grow oxide inside the removed portion to expand the size of the removed portion.

6. The method of claim 5, wherein the size of the expanded portion is increased to provide the tilted probe tip that has the engagement surface tilted relative to the cantilever axis at an angle between 8°-15°.

7. The method of claim 1, wherein removing the portion of the probe includes implanting a selectively expandable material within the removed portion of the probe.

8. The method of claim 7, wherein the selectively expandable material is an implanted doped silicon.

9. The method of claim 8, wherein the size of the expanded portion is increased to provide the tilted probe tip that has the engagement surface tilted relative to the cantilever axis at an angle between 8°-15°.

10. The method of claim 2, wherein the removed portion of the probe is a portion of the probe tip.

11. The method of claim 1, a distal end of the tip having the engagement surface substantially parallel to at least one of the cantilever axis and a surface of a sample.

12. A probe device for a surface analysis instrument including a probe holder, the probe device comprising:
a cantilever defining a longitudinal cantilever axis; and
a tilted probe tip having an engagement surface, an angle of the engagement surface deviating from being parallel with the longitudinal cantilever axis; and
wherein the probe device includes an expanded filler in a removed portion of the probe device and the size of the removed portion is modified by the expanded filler to provide the angle.

13. The probe device of claim 12, wherein the removed portion of the probe device is a portion of the cantilever.

14. The probe device of claim 13, wherein the angle is about 8°-15°.

15. The probe device of claim 14, wherein the cantilever is made of silicon nitride (SiₓN_{y}), and the probe device is batch fabricated from a wafer using photolithography.

16. The probe device of claim 15, wherein the expanded filler includes oxide grown using LOCOS oxidation.

17. The probe device of claim 16, wherein the size of the expanded portion is increased to provide the tilted probe tip that has an engagement surface tilted relative to the cantilever axis at an angle between 8°-15°.

18. An AFM probe device microfabricated by a process comprising the steps of:
providing a wafer;
creating a plurality of probes formed from the wafer, the probes including a cantilever and a probe tip;
removing a portion of one or more of the plurality of probes; and
increasing or decreasing the size of the removed portion of the one or more probes to generate a tilted probe tip having an engagement surface that deviates from being parallel with a longitudinal cantilever axis of the cantilever for the probe.

19. The probe device of claim 18, wherein the removed portion of the probe is a portion of the cantilever.

20. The probe device of claim 19, wherein increasing or decreasing the size of the removed portion of the probe includes using LOCOS oxidation to selectively grow oxide inside the removed portion to expand the size of the removed portion.
